(19) United States
(12) Patent Application Publication
(10) Pub. No.: US 2013/0290075 A1
(43) Pub. Date: Oct. 31, 2013

(54) LOCALIZATION QUALITY ASSURANCE OF LOCALIZED SOFTWARE

(71) Applicant: INFOSYS LIMITED, Bangalore (IN)

(72) Inventors: Satya Prabh Kathooria, Mohali (IN); Perminder Singh Vohra, Mohali (IN); Saurabh Kashyap, New Shimla (IN); Sudhir Srivastava, Panchkula (IN); Ritesh Parmar, Mandi (IN); Sumit Goyal, Chandigarh (IN)

(73) Assignee: Infosys Limited, Bangalore (IN)

(21) Appl. No.: 13/867,976

(22) Filed: Apr. 22, 2013

(30) Foreign Application Priority Data
Apr. 30, 2012 (IN) 1676/CHE/2012

(51) Int. Cl. G06Q 10/06

(52) U.S. Cl. CPC G06Q 10/06395
USPC 705/7.41

(57) ABSTRACT

Described herein are representative embodiments for localization quality assurance (LQA) of localized software. In one exemplary implementation, a localization quality assurance plan for performing LQA of a localized software based on a base-language software is developed, and using the localization quality assurance plan, the LQA is performed for the localized software at least by performing a first test phase of one or more test phases. In the first test phase, one or more screen maps are created for a localized-software build using first location resources at a first location, and the one or more screen maps are evaluated using second location resources at a second location. Also, one or more resource bundles for the first localized-software build are generated based on the evaluating of the one or more screen maps. Additionally, a second localized-software build is generated using the first location resources based on the one or more resource bundles.

### FIELD

The field relates to quality assurance of software, and particularly to localization quality assurance of localized software.

### BACKGROUND

As globalization of software has become more prevalent, software providers expend significant resources localizing their software products. Traditionally, software testing has been done as part of the localization process, however traditional methods are limited.

### SUMMARY

Among other innovations described herein, this disclosure presents various tools and techniques for localization quality assurance of localized software. In one exemplary technique described herein, a localization quality assurance plan for performing localization quality assurance of at least a localized software based at least on a base-language software is developed, and using the localization quality assurance plan, the localization quality assurance of the localized software is performed at least by performing a first test phase of one or more test phases.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the technologies will become more apparent from the following detailed description, which proceeds with reference to the accompanying figures.

### BRIEF DESCRIPTION OF THE DRAWINGS

FIG. 1 is a flowchart of an exemplary method for performing localization quality assurance of a localized software using a localization quality assurance plan.

FIG. 2 is a flowchart of an exemplary method of performing a test phase of localization quality assurance of a localized software.

FIG. 3 is a flow diagram of an exemplary method for performing localization quality assurance of a localized software.

FIG. 4 is a schematic diagram illustrating an exemplary method of developing a localization quality assurance plan.

FIG. 5A illustrates a portion of an exemplary implementation of a screen map.

FIG. 5B illustrates a portion of an exemplary implementation of a screen map.

FIG. 6 illustrates an exemplary implementation of a stakeholder matrix.

FIG. 7 illustrates an exemplary implementation of a feature test release plan.

FIG. 8 illustrates an exemplary implementation of a testing-activities coverage matrix.

FIG. 9 is a schematic diagram illustrating an exemplary communication plan.

FIG. 10 illustrates an exemplary implementation of a localization quality assurance roadmap.

FIG. 11 is a schematic diagram illustrating an exemplary computing system for performing localization quality assurance of a localized software.

FIG. 12 is a schematic diagram illustrating a generalized example of a suitable computing environment for any of the disclosed embodiments.

### DETAILED DESCRIPTION

### Exemplary Method for Performing Localization Quality Assurance of a Localized Software Using a Localization Quality Assurance Plan

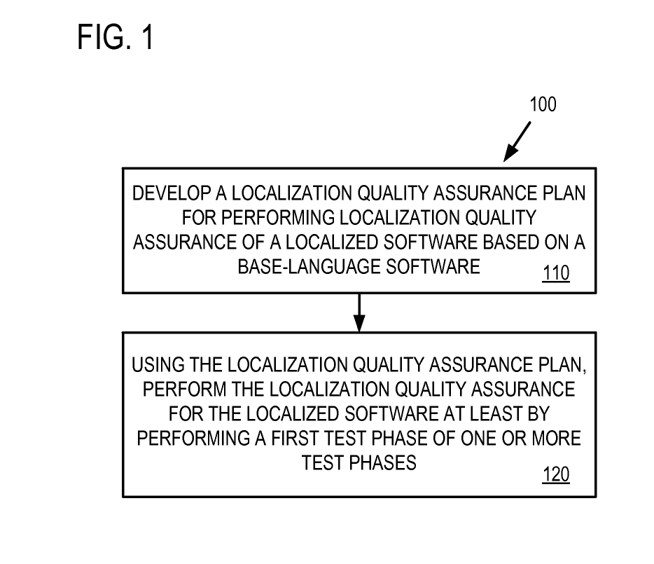

FIG. 1 is a flowchart of an exemplary method 100 for performing localization quality assurance (LQA) of a localized software using a localization quality assurance plan (LQA plan). In the example, an LQA plan for performing LQA of at least one localized software based on a base-language software is developed at 110. For example, the LQA plan can include an assignment of a set of one or more localization quality assurance tasks (e.g., tasks to be performed for LQA of a localized software), that can include functional quality assurance (functional QA), engineering, and/or management tasks, to first resources (e.g., a functional QA, engineering, management team, and/or other resources) at a first physical location, and an assignment of a second set of localization quality assurance tasks that can include linguistic tasks to second resources (e.g., the second resources can include a linguistic translation team, a linguistic validation team, and/or other resources) at a second location. At 120, LQA of the localized software is performed using the LQA plan. For example, LQA of a localized software can be performed by executing one or more localization quality assurance activities or tasks as planned in the LQA plan.

In one example, the localized software can be a modified version of a base-language software that is in a base language. For example, a base-language software can be a software that includes a user interface in a first or base language that can be used to create a localized software that includes a user interface in a different language. Alternatively, the software may already support multiple languages, but one or more other languages are added by modifications. The modifications can include translations of screen elements into a language different than the base language, internationalization modifications, and other modifications.

Also for example, in performing the LQA of the localized software using the LQA plan, one or more test phases can be performed. In some implementations, the one or more test phases can include performing one or more localization quality assurance testing activities or tasks that test a build of the localized software. Also, the one or more test phases can include the creation of one or more screen maps from a first localized-software build at the first location using the first resources, and the one or more screen maps can be evaluated at the second location using the second resources. Also, based on the evaluated screen maps, one or more resource bundles can be created for the localized-software build. Further, a second localized-software build can be generated based at least in part on the one or more resource bundles. For example, information included in the one or more resource bundles can be used to modify the localized software (e.g., the source code) to create a different version of the localized software in a second localized-software build.

### Exemplary Method of Performing a Test Phase for Performing Localization Quality Assurance of a Localized Software

In performing LQA of a localized software, one or more test phases can be conducted. The test phases can be iterative, and a test phase can be performed on a localized-software build. For example, a first test phase can be conducted on a first localized-software build, and a second test phase can be conducted on a second localized-software build.

The number of test phases for performing LQA of a localized software can be determined and set in an LQA plan (e.g., N test phases). In one example, during the development of an LQA plan the number of test phases can be chosen based on an amount of testing coverage to be done and an amount of time that would be needed for the testing. For example, in one implementation, an LQA plan can indicate that four test phases are to be conducted in the performance of LQA of a localized software. In other implementations, more or less test phases are performed in performing LQA of a localized software.

In some implementations of a localized-software LQA project, using iterative test phases can provide for effective coverage and/or the ability to use localization quality assurance teams in early stages or test phases of the LQA project for the localized software. In some implementations of a localized-software LQA project, the LQA plan designates one or more localization quality assurance activities or tasks to be performed in respective test phases. This can reduce testing time by segregating different localization quality assurance testing activities so that there can be limited (e.g., a minimum and/or reduced degree of) repetition of testing activities while providing sufficient (e.g., broad and/or complete) testing coverage.

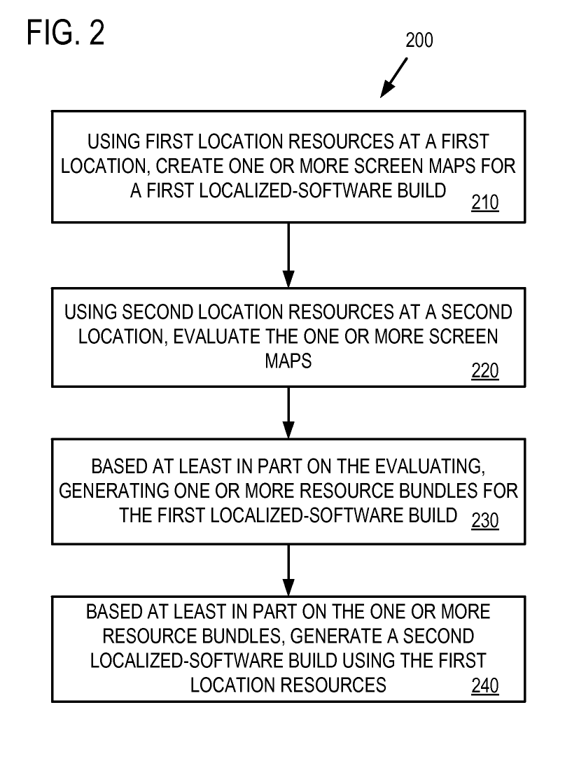

FIG. 2 is a flowchart of an exemplary method 200 of performing a test phase of LQA of a localized software. In some examples of performing a test phase, one or more localization quality assurance activities or tasks of the test phase are executed or performed as planned in the LQA plan. In FIG. 2 at 210, one or more screen maps for a first localized-software build are created using first location resources at a first location. For example, one or more screen maps can be created from screens of a base-language software and from screens of a version or build of the localized software. The screen map can include a screenshot of a screen in the base-language software that displays screen elements in the base language and a screenshot of a corresponding screen in the localized-software build that displays screen elements in the second language of the localized software. That is to say that, the localized-software screenshot can display a translated version of the screen displayed in the base-language screenshot, and can include one or more translated screen elements that correspond to and are translations of one or more screen elements in the base language screen.

In some implementations, a screen map can include a purpose section that can include a purpose for the screen map, a screens section that can include a screen evaluation chart, a screen details field, a base-language screenshot field that includes a screenshot of a screen in the base-language software, a localized-software screenshot field that includes a screenshot of a screen in the localized-software build, and/or a verification field. In other implementations, a screen map can have fewer or more fields and include more or less information.

In FIG. 2 at 220, the one or more screen maps are evaluated using second location resources at a second location. For example, the one or more screen maps can be sent from the first location by at least a functional QA team to a linguistic validation team at the second location, and at the second location the one or more screen maps can be evaluated for defects such as translation errors, misspellings, typographic, and other linguistic errors displayed in the readable screen elements of the localized-software screenshots included in the one or more screen maps. The evaluation of the one or more screenshots can include a validation of a translation of a screen or one or more screen elements in a screen map. For example, a linguistic validation team member can view the base-language screenshot and the corresponding localized-software screenshot and decide and indicate that the translation of the screen in the base language is correct and/or correctly translated as displayed in the localized-software screen captured in the screen map.

Also, the evaluation of the one or more screen maps can include an indication that a translation of a screen or one or more screen elements in a screen map is not validated. For example, a linguistics team member can view the base-language screenshot and the corresponding localized-software screenshot and indicate that the translated screen includes a linguistic defect or error in translation or other linguistic error. In some examples, the error is indicated by the linguistics team member on a screenshot or a validation section of the screen map. In one implementation, the text or characters of the translated or base language screen element is included in the indication that the translation is not correct. In other implementations, found linguistic defects are noted, logged, or communicated in another manner. In some implementations, functional defects are noted, logged, or communicated when found while testing the localized-software build.

In some implementations of a localized-software LQA project, using screen maps for validation of a user interface allows the linguistic teams to perform linguistic tasks without other stakeholders having to impart product functionality knowledge to members of the linguistic teams.

At block 230, one or more resource bundles for the first localized-software build are generated based at least in part on the evaluation of the one or more screen maps. For example, if a screen map is evaluated and a screen element in a localized-software screenshot is indicated, in the screen map, as being not validated or not verified for having an improper translation (e.g., a screen element is not properly translated) or other error (e.g., a linguistic defect), one or more members of the linguistics team at the second location (e.g., one or more members of a linguistic translation team) can provide a corrected translation of the screen element and/or a correction to a linguistic defect and the correction and/or the translation can be captured in a resource bundle.

In one example, a resource bundle includes a document or file that includes one or more translations of text or characters of a screen element in the base language software to be included in the localized software or a subsequent localized-software build. The translations can be corrected translations of screen element translations of a localized-software build or errors shown in a screen map derived from screens of a localized-software build. In one example, the document or file contains a new or different translation of a screen element displayed in an evaluated screen map. The translations can be corrections (e.g., corrections of translations, spellings, or other corrections) to screen elements that are not validated (e.g., validated as being correct) in the evaluation of the screen map documents. In some implementations, resource bundles include one or more portions of source code that are modified to include the corrections or fixes to the defects found in the linguistic validation of the screen maps. That is to say the resource bundles include corrections to the errors that caused the previously evaluated localized-software screenshot to display an incorrect translation and/or other error. In some implementations, a resource bundle includes a key that identifies and/or is associated with a screen element, text, string, and/or characters in a screen of the localized software that can be translated, and the resource bundle can include a translation of the screen element, text, string, and/or characters that are associated with the key.

The source code that is modified can be the version of source code used to create the localized-software build from which the evaluated screen map documents were created. In another implementation, an earlier or later version of the localized-software source code is modified and included in the resource bundle. In a further implementation, a resource bundle can include translated strings of the user interface for inclusion into a subsequent version of the localized software under which LQA is being performed, such as a subsequent localized-software build.

In another implementation, an initial resource bundle can include untranslated strings, text or characters for translation. For example, before a first localization-software build is available, one or more initial resource bundles can be created at the first location by a first team (e.g., an engineering, coding, and/or functional QA team) that include text or characters of screen elements in the base language that can be sent to the linguistic team at the second location for initial translation to the language to be used in the localized software. The initial translations can then be incorporated by the first team into the localized software to produce a localized-software build (e.g., a first localized-software build). In another implementation resource bundles for initial translation of base language screen elements can be provided or sent to linguistic team members at one or more times throughout the process of LQA of the localized software including before or after developing one or more localized-software builds.

In some implementations of sending, receiving, or providing information from one team to another team, the information (e.g., screen maps, resource bundles, and/or other information) can be sent from a computer and received at another computer (e.g., via a communications network). Also in some implementations of sending, receiving, or providing information from one team to another team, the information is sent to and received by a centralized server or software from a computer that is connected with the centralized server or software by a communications network. Information that is stored using a centralized server or software can be accessed by stakeholders to perform one or more localization quality assurance activities or tasks. In some implementations, one or more localization quality assurance activities or tasks can be performed using a centralized server or software that can be accessed by stakeholders at different locations.

At block 240, a second localized-software build is generated using the first location resources based at least in part on the one or more resource bundles. For example, the resource bundles that are created from the linguistic team can be sent to an engineering team at the first location and the engineering team can include the information from the resource bundles into the source code for the localized software that was used to generate the first localized-software build producing an updated version of the source code for the localized software. With the incorporated information from the resource bundles in the updated source code, the updated source code for the localized software can be compiled and/or otherwise generated into a second software-build. The screens of the second localized-software build can display the translations of the screen elements provided in the one or more resource bundles for the previous localized-software resource build.

Additionally, in some implementations of one or more test phases, the test phases include performing one or more other localization quality assurance testing activities or tasks included in quality assurance testing. In one implementation of performing LQA of a localized software, the software is produced using four test phases. For example, an initial test phase can include build validation testing, sanity testing, internationalization testing, and screen capturing. A next iterative test phase can include functional testing, linguistic validation testing, and/or build validation testing. A next or subsequent test phase can include functional testing, integration testing, linguistic validation testing, build validation testing, and/or automation testing. A last test phase can include build validation testing, sanity testing, and/or document testing. In other implementations of performing LQA of a localized software, the software is produced using the same or a different amount of test phases and the test phases can include more or fewer and/or the same or different localization quality assurance testing activities.

### Exemplary Method for Performing Localization Quality Assurance of a Localized Software

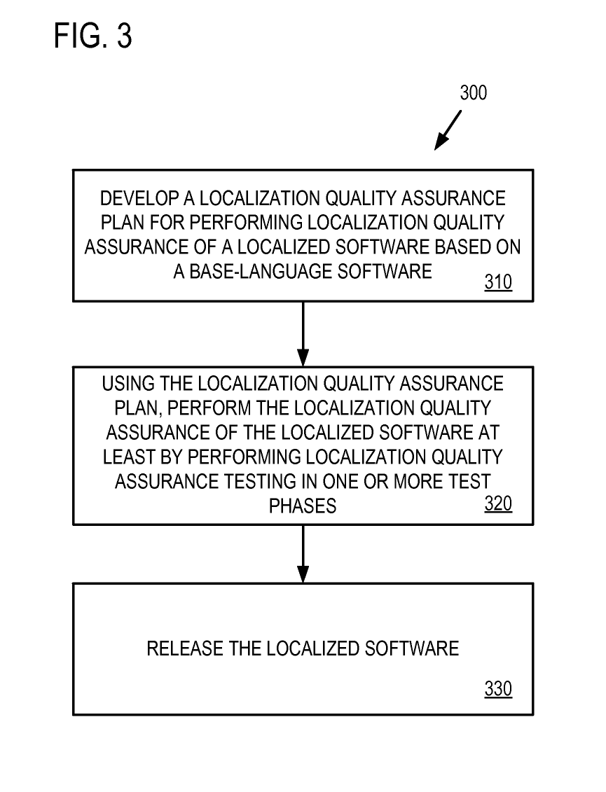

FIG. 3 is a flow diagram of an exemplary method 300 for performing localization quality assurance of a localized software. In some implementations of performing LQA of a localized software, a localized software is tested so that it functions and has a user interface that is well-suited for users of a particular location and/or that use a language. In some implementations, a localized software is internationalized to be compatible with data sets or computing systems available in a location or country, and the internationalized localized software can be an internationalized software build. Also, in some implementations, a localized software is localized to include a user interface that displays information in a language used in a location where the localized software is to be used. In FIG. 3 at 310, an LQA plan is developed for performing LQA of at least one localized software that is based on a base-language software. For example, planning and scoping for the LQA of a localized product (e.g., a localized-software LQA project) can be done. In some implementations of a localized-software LQA project, an input for starting the project is an internationalized build of the software with a localized user interface. In other implementations of a localized-software LQA project, localization quality assurance teams can begin localization quality assurance (LQA) in parallel to engineering activity where a partial set of features in the software are being internationalized and localized during one or more phases of the localized-software LQA project.

At 320, the localization quality assurance for the localized software is performed at least by performing localization quality assurance testing (LQA testing) in one or more test phases. For example, after an LQA plan has been completed, LQA for a localized software can be accomplished at least by performing one or more test phases. In other implementations, the performance of LQA of the localized software can begin while an LQA plan is being developed. In some implementations, performing LQA of the localized software includes localization quality assurance testing where one or more localization quality assurance testing tasks or activities are performed.

Localization quality assurance testing (LQA testing) can include a quality assurance process that can improve the quality of the localized software product produced. In some implementations of test phases, a localized-software build of the localized software can be generated for the test phase and the localized-software build can undergo LQA testing and evaluation activities of the test phase. In some implementations of a test phase, a functional quality assurance team (functional QA team) collaborates with a linguistic validation team to perform localization quality assurance testing of the software through localization quality assurance testing activities. The functional QA team can perform the tasks assigned to the team according to the LQA plan, and the linguistic validation team can perform the tasks assigned to the linguistic validation team in the LQA plan, and the coordination and cooperation between the two teams can also be conducted according to the LQA plan. Dividing up localization quality assurance tasks between teams and performing LQA of a localized software according to an LQA plan can save time, improve cost benefits, and improve quality and productivity gains over traditional localization processes. In some implementations, a linguistic validation team does not include people (e.g., any people) from a linguistic translation team, and the LQA activities assigned to the linguistic validation team are performed by the linguistic validation team (e.g., only by the linguistic validation team) and are not performed by the linguistic translation team. In another implementation, the linguistic validation team can include at least one person from the linguistic translation team. For example, when there are fewer resources for a localized-software LQA project, the linguistic validation team and the linguistic translation team can include and share at least one person who can perform one or more LQA activities assigned to either of the two teams in the LQA plan. In some implementations of LQA of a localized software, LQA testing can be divided into four test phases or test phase iterations. For example, having four test phases can provide a balance of testing coverage and elapsed duration for the testing. In other implementations of performing LQA of a localized software, more or fewer than four test phases or test phase iterations can be performed.

In some implementations of the process of performing LQA of a localized software, various inputs are generated before the process begins or during the process. For example, the inputs to an LQA process can include a project schedule, base language screen maps created during on-boarding activities, quality metrics of an LQA plan, functional test plans, test specifications, a feature test release plan for respective test phases, a testing-activities coverage matrix, localization quality assurance standards, a supporting language set, a defect severity/priority classification, and/or acceptance criteria of respective test phases.

During the performance of LQA of a localized software, screen capture activity is conducted. For example, one or more screen maps are created from a localized-software build. The screen maps can include screen shots of the localized software along with or mapped with corresponding screenshots of screens of the base language software. In some implementations, a screenshot in the localized software corresponds to the screenshot of the base language software such that one or more screen elements (e.g., readable text or characters) in the localized software screenshot are translations of one or more screen elements in the base language software screenshot. In some implementations, the corresponding screenshots of the localized software and the base language software correspond such that they represent the same or similar screen in the respective localized and base language versions of the software and convey the same, substantially same, and/or similar information in different languages (e.g., they are the same screen in the respective softwares translated in different languages). For example, the corresponding screenshot from the localized software can be from a screen that has been translated from the screen in the base-language software that is shown in the base language screenshot. That is to say, that the screenshot from the localized software can be a translated version of the base-language software screen that is used to create the corresponding base language screenshot. In some implementations, the corresponding screenshots of the localized software and the base language software correspond such that they are identified as corresponding screens. For example, the screens can have identification information such as an identification number or readable information that indicates they are corresponding screens in the respective localized software and the base language software. In other implementations, the corresponding screens are identified using other methods to indicate that the screens are corresponding or that the screens are to be included in a screen map together for translation validation and/or evaluation. In some implementations of performing LQA of a localized software, the LQA task of creating the screen maps is assigned to the functional QA team. The functional QA team can create the screen maps and send them to a linguistic validation team at a different location. In some implementations, the functional QA team and the remotely located linguistic team are in different cities, different countries, or other locations that are different.

In some implementations, the remotely located linguistic team is at a location (e.g., city, state, province, country) where people of the location predominantly speak, know, or otherwise use a language that is different than the base language of the base-language software and/or a different language than the language that is predominantly spoken, written, known, or otherwise used at the location where the functional QA team is located. For example, when performing LQA of a localized software in the Italian language, the remotely located linguistic team can be located at one or more places in Italy, or another location where the Italian language is used or spoken natively, and the functional QA team and/or the engineering team can be located in a different or remote location.

Creating and using linguistic teams that perform their work in their base locations (e.g., locations where the language to be used in the localized software is used by many people and/or the team members) can help to create efficiencies for localized-software LQA projects. For example, the linguistic team does not have to relocate from their base location to work on the localized-software LQA project. In some implementations, a linguistic team can include a linguistic validation team which evaluates the screen maps for validation and/or indication that there are linguistic, translational, typographical, cultural, and/or formatting defects (e.g., errors or other inaccuracies) included (e.g., displayed) in the localized-software screenshots of the screen maps. Also, in the evaluation of the screen maps, the linguistic validation team can indicate that a screen or screen element displayed in the screen map is not validated due to a defect and/or error found in the screenshot. In some implementations, the linguistic validation team reports defects found in the evaluation of the screen maps to an engineering team and/or linguistic translation team for correction or fixing. For example, internationalization defects found in the evaluation of screen maps can be logged and sent to and corrected or fixed in the localized software by an engineering team. The engineering team can change the source code or fix the defects in some other manner of updating the localized software. Also for example, translation defects found in the evaluation of screen maps can be logged and sent to and corrected or fixed by a linguistic translation team. In one implementation, a screen map is updated by the linguistic validation team to indicate the defect and the screen map is sent to the linguistic translation team to be fixed or properly translated. The linguistic translation team can provide and include corrected translations or other linguistic corrections in one or more resource bundles. The resource bundles can be sent to the engineering team and the information or a portion of the information (e.g., translated UI strings, text, or characters) in the resource bundles can be used by the engineering team to update the localized software (e.g., at least a portion of the information can be included in a localized-software build). In some implementations, resource bundles that are created by the localization translation team (i.e., translated resource bundles) can be evaluated by the localization validation team.

In some implementations of a localized-software LQA project, defect fixes along with features planned to be released in a test phase are included in a localized-software build that is built and given to one or more teams for testing during the planned testing phase. In the planned testing phase defect verification and/or correction validation is performed along with one or more testing activities. In some implementations, UI screenshots captured in the screen maps can also be used to create localized help documents or artifacts for the localized software product. For example, the screenshots or portions of the screenshots captured for one or more screen maps can be included in one or more help documents or files for the localized software. During the localized-software LQA project, one or more quality metrics developed for the LQA plan are used to track the effectiveness of the execution of the developed LQA plan and the localized-software LQA process. For example, expected values or target values set for a quality metric that is included in the LQA plan can be compared to actual values measured during the performance of LQA of the localized software to track effectiveness of execution.

In some implementations of the process of performing LQA of a localized software, a verified localized-software build can be created that includes fixes from one or more previous test phases that are verified as included in the build. In some implementations of performing LQA of a localized software, verified translated documents and/or help files can be created that are translated documents associated with the localized software that have been evaluated and validated as properly translated. In some implementations of performing LQA of a localized software, translation and validation of documents and manuals are included as part of the LQA of the localized software and the translated documents and manuals can be included in the localized software product. Additionally, in some implementations of performing LQA of a localized software, a localization quality assurance report can be created that includes defect details.

With reference to FIG. 3, the localized software is released at 330. In some implementations of releasing the localized software, bug triaging can be conducted. For example, defects identified in completed test phases are fixed and reflected in the localized software. Also during the releasing of a localized software, a localization quality assurance report can be generated and shared with one or more stakeholders. During the releasing of a localized software, a decision to release the localized software for use by customers or consumers or for general availability (GA) can be made based on the localization quality assurance report. In some implementations of releasing a localized software, suggestions from stakeholders are provided to decision makers about the suitability of the localized software for release. Also, in some implementations of releasing a localized software, a localization quality assurance group can approve the localized software product for a release to market and/or manufacturing when one or more previously identified defects have been fixed. After the product is released to manufacturing, the localized software can be made generally available through the internet and/or as included in computer readable media. In some implementations, of releasing a localized software, the releasing of the localized software is part of the LQA of the localized software.

### Exemplary Method of Developing a Localization Quality Assurance Plan

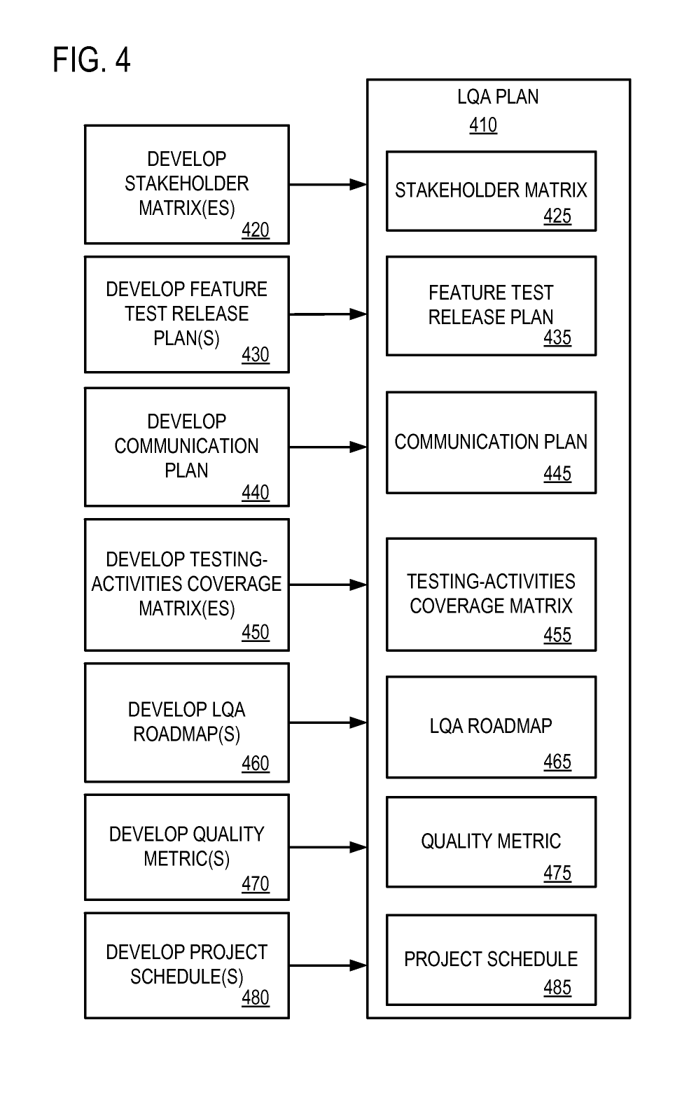

FIG. 4 is a schematic diagram illustrating an exemplary method of developing a localization quality assurance plan 410. An LQA plan can be a plan for the planning, performing LQA, and/or releasing of one or more localized softwares. That is to say an LQA plan can be a plan for one or more localized-software LQA projects that includes a description of work/responsibility segregation (e.g., with abstraction or otherwise). In some implementations, by designating responsibilities between various stakeholders, time can be saved in performing LQA of a localized software.

In some implementations of an LQA plan, the LQA plan can be developed using one or more stakeholders and/or using one or more software and/or computing resources. For example, stakeholders can provide information to a software tool as part of developing an LQA plan. In the figure at 420, one or more stakeholder matrices for the LQA plan are developed such as stakeholder matrix 425. The stakeholder matrix 425 indicates assignments of one or more localization quality assurance tasks to one or more stakeholders. The one or more stakeholders can include a management team, an engineering team, a functional QA team, a linguistics team (e.g., a linguistic translation team and/or a linguistic validation team), and/or other stakeholders involved in the LQA of the localized software. The one or more localization quality assurance tasks or activities can include tasks or activities to be performed in localization quality assurance of and/or release of a localized software. In one implementation, the stakeholder matrix 425 can include an assignment of one or more sets of one or more localization quality assurance tasks (LQA tasks) that are functional QA, engineering, and/or management tasks to first resources (e.g., the first resources can include stakeholders such as a functional QA, engineering, management team, and/or other resources) at a first physical location, and an assignment of one or more sets of LQA tasks that are linguistic tasks to second resources (e.g., the second resources can include stakeholders such as a linguistic translation team, a linguistic validation team, and/or other resources) at a second location. In some implementations of resources, resources can include human resources (e.g., stakeholders), infrastructure, tools, software, computers (e.g., one or more sets of computers), and other resources that can be used in localization quality assurance of a software.

In one implementation, the stakeholder matrix divides localization quality assurance tasks between various stakeholders such that the stakeholders are responsible for conducting the tasks that are better suited for their skill sets or that are within their skills domain (e.g., the stakeholders are able to perform the task). In some implementations, functional QA testing can be performed (e.g., using one or more computers) by functional experts, linguistic tasks can be performed by linguistics experts, and engineering tasks can be performed by engineering experts. For example, a linguistics team with one or more members that are skilled (e.g., fluent, experienced, and/or educated) in a language that is used in a particular location can be assigned LQA tasks that are linguistic tasks (e.g., translation, translation validation, and/or other linguistic tasks) involving the language known by the team member and used in the localized software. These linguistic tasks can be language translation tasks or language evaluation or validation tasks.

In some examples of stakeholder matrices, a linguistics team with one or more members that are skilled in a language can be assigned LQA tasks that are linguistic tasks such as providing language translation for resource bundles and software documents and artifacts, performing translation/localization defect fixing (e.g., providing translated text or characters correcting readable errors displayed by a screen of a localized-software build), and/or other localization quality assurance tasks. In some examples of stakeholder matrices, a linguistic validation team with one or more members skilled in a language can be assigned LQA tasks that are linguistic tasks such as validating the translation and localization of the localized software from the base language software, receiving screen maps from another team at another location (e.g., a functional QA team), performing evaluations of screen map documents, performing resource bundle translation validation and document/artifact translation validation, logging linguistic/formatting defects, verifying translation defect fixes, participating in decision making for the release of the localized software, and/or other LQA tasks.

Also, in some examples of stakeholder matrices, an engineering team with one or more members that are skilled in building, writing, or developing software can be assigned LQA tasks or activities that are related to internationalization of a localized software, integrating information from resource bundles into the code of a localized software, building one or more localized-software builds, creating initial resource bundles, providing initial resource bundles to linguistics teams for translation, fixing functional or internationalization defects, and/or other localization quality assurance tasks.

With reference to FIG. 4, at block 430, one or more feature test release plans are developed such as feature test release plan 435. The feature test release plan 435 can be used to plan, perform, and/or track iterative feature testing across one or more test iterations (e.g., over one or more iterative test phases). Feature test release plan 435 can include an enumeration of one or more features planned to be included in the localized software that are to be tested during the LQA of the localized software, an enumeration of feature test plans for testing the enumerated one or more features of the localized software, and fields for tracking the testing of the one or more features using the one or more test plans over one or more test phases. In one implementation, the feature test release plan is created to provide a tool to track feature testing coverage and to provide a plan for consistent and parallel engagement of one or more stakeholder teams with one or more other stakeholder teams. For example, the feature test release plan can provide a plan for consistent and parallel engagement of localization quality assurance teams and with an engineering team. Localization quality assurance teams can include a linguistic validation team, a functional QA team, and/or other teams performing localization quality assurance testing and validation tasks.

At block 440 of FIG. 4, one or more communication plans are developed such as communication plan 445. Communication plan 445 can illustrate how interaction or communication between various stakeholders can occur during the LQA of the localized software. For example, a communication plan can include one or more documents that indicates a plan for the flow of information between one or more teams over one or more phases of the localization quality assurance process for the localized software.

At block 450, one or more testing-activities coverage matrix plans are developed such as testing-activities coverage matrix 455. In one implementation, a testing-activities coverage matrix can include a listing of various localization quality assurance testing activities to be performed during different test iterations or test phases of an LQA process for a localized software. For example, a testing activities matrix can list when various types of localization quality assurance testing tasks or activities are to be performed during the LQA of the localized software. In some implementations, LQA testing types can include build validation testing, sanity testing, localizability testing, user interface validation testing, screen capture testing, functional testing, integration testing, translated document testing, or help verification testing.

At block 460, one or more localization quality assurance roadmaps are developed such as localization quality assurance roadmap 465. In one implementation, a localization quality assurance roadmap (LQA roadmap) can include one or more documents that indicate a plan for sharing resources such as human resources, infrastructure resources, and tools. For example, an LQA roadmap can be developed to indicate how resources are to be used between different localized-software LQA projects, where localization quality assurance (LQA) is targeted for multiple language sets or for different project portfolios running within an organization.

In one implementation of the development of an LQA roadmap when a localized-software LQA project begins, core team members can be identified. The core team members can be team members that are to remain with a project throughout its duration. Also, other non-core team members can be identified that contribute to (e.g., come on board, or join) the project for an on-board duration of time when they are needed.

In one implementation, the non-core team members' contribution can include work or performing tasks regarding their respective domains, technological skills, and/or linguistic skills In some implementations of localized-software LQA projects, when a phase or an on-board duration is complete, the non-core team moves on or transitions to a different project. For example, the resources that are doing localization quality assurance planning (e.g., developing an LQA plan) for a first localized-software LQA project can leave the first localized-software LQA project and join or begin localization quality assurance planning for a second localized-software LQA project when the planning for the first project is finished.

In another implementation, non-core team member resources that are allocated to contribute during one or more respective test phase of a first localized-software LQA project can move to contribute on one or more other localized-software LQA projects when their planned contributions to the first project are finished. In a further implementation, infrastructure can be shared between different localized-software LQA projects and a plan for sharing the infrastructure resources can be included in the LQA roadmap. For example, infrastructure can be shared using virtual machines with localized setups. These virtual machines can be used across different localized-software LQA projects or test phases and can save on setup time and infrastructure costs for the respective projects. Also, for example, tools and accelerator setups and licenses can be procured and can be used across or for multiple cycles, test phases, and/or localized-software product portfolios.

At block 470, one or more quality metrics are developed such as quality metric 475. In one implementation, a quality metric can be developed for gauging effectiveness. For example, a quality metric can include an expected defects rate metric (e.g., DIR, DRE, or the like), a translation quality metric, a productivity metric, and/or other quality metric. In one implementation the one or more quality metrics can be included in a quality matrix that can include a schedule, expected defect numbers, defect-types, defect distributions, and/or a level of translation quality. In some implementations of a localized-software LQA project, quality metrics are used at various stages throughout the LQA project and/or to gauge effectiveness at release.

At block 480, one or more project schedules are generated such as project schedule 485. For example, a schedule for a localized-software LQA project such as planning LQA, performing LQA, and releasing a localized software can be determined and captured in a project schedule. In one implementation of a localized-software LQA project, a project schedule and quality metrics can be determined in early stages for gauging effectiveness, or in other stages of the LQA process.

In FIG. 4, the LQA plan 410 includes plan elements such as the stakeholder matrix 425, the feature test release plan 435, the testing-activities coverage matrix 455, the communication plan 445, the LQA roadmap 465, the project schedule 485, and quality metric 475. In other implementations, an LQA plan can include more or fewer plan elements that plan and track LQA of a localized software. For example, a subset of the plan elements shown in the LQA plan 410 can be possible.

### Exemplary Localized-Software Build

In some implementations, a localized-software build can be a version or build of a localized software. For example, throughout the duration of the test phases for LQA of the localized software, the software and the source code for the software can undergo changes and updates, and these changes and updates create various versions of the software and code. A localized-software build can be a compiled, executable, and/or testable version of the software from the software source code. There can be more than one localized-software build throughout the duration of the test phases for LQA of the localized software. In some implementations, the produced and finished localized software that is released can be a localized-software build. In some implementations of localized-software builds, the features included in the localized-software build are the features indicated in a feature test release plan for release in the testing phase in which the localized-software build will be or is planned to be tested. Also, localized-software builds can include fixes to defects, errors, bugs that were identified during testing of previous localized-software builds.

### Exemplary Implementation of a Screen Map

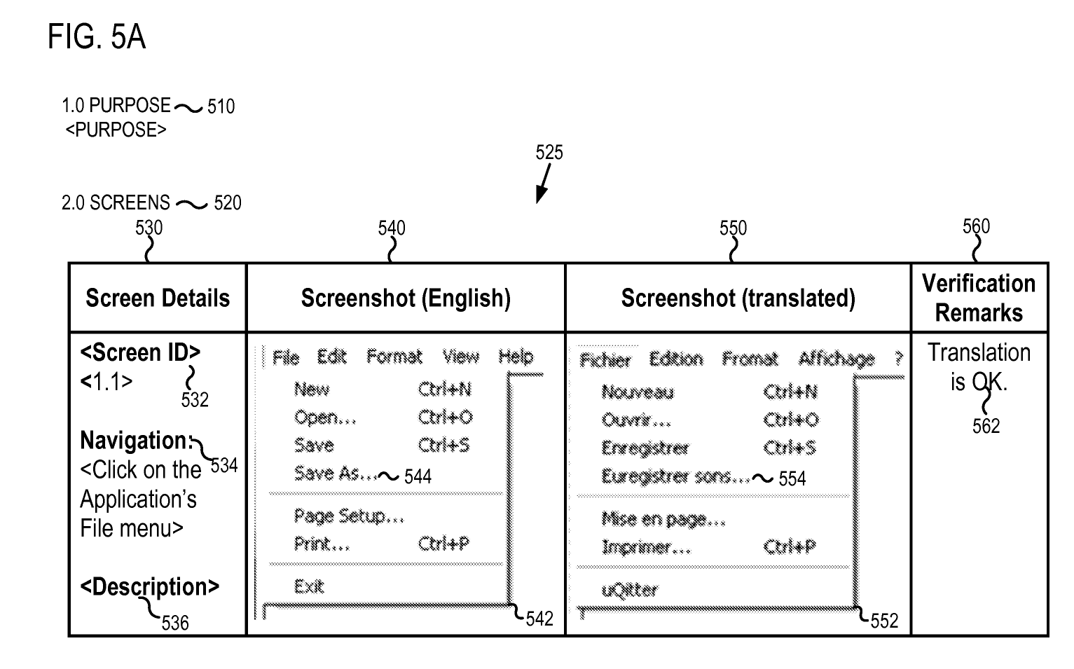

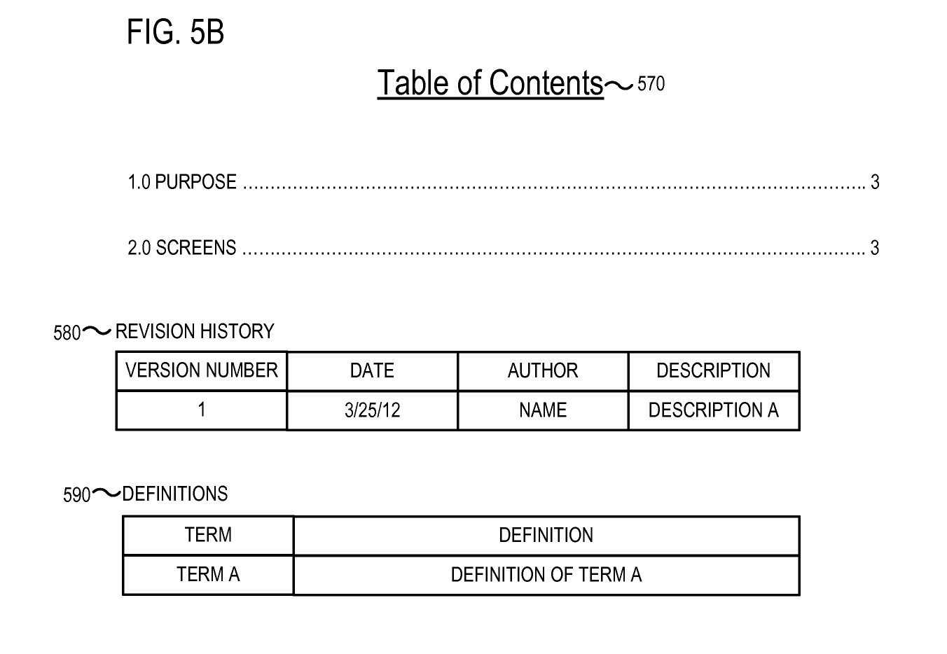

In the performance of LQA of a localized software, screens of a build of the localized software can be captured and used as a tool in the linguistic validation of the localized software. That is to say that the linguistic validation of the localized software's user interface can be based on screen capture activity of the localized software. Screen capture can be done to create screen maps which include user interface (UI) screenshots of the localized software or a build of the localized software. A screen map can include UI screenshots of a localized software including a localized-software build mapped against UI screenshots of the base-language software that the localized software is based on or translated from as shown in the exemplary screen map of FIGS. 5A-B. Linguistic-validation-team members can use the screen maps for linguistic evaluations and/or validations of the localized software.

FIG. 5A illustrates a portion of an exemplary implementation of a screen map. In the figure, the screen map includes a purpose section 510 that includes a purpose for the screen map. The screen map includes a screens section 520 that can include one or more screen evaluation charts such as screen evaluation chart 525. Screen evaluation chart 525 includes a screen details field 530, a base-language screenshot field 540, a localized-software screenshot field 550, and a verification field 560. In other implementations a screen evaluation chart can have fewer or more fields, and the fields can be arranged differently. For example a field evaluation chart can include multiple screenshots from more than one localized-software builds that are translated into multiple languages.

The screen details field includes a screen identification field 532 that identifies (e.g., uniquely identifies) the screens in the base language software and the localized software captured for evaluation in the screen evaluation chart 525. The screen details field 530 also includes a navigation field 534 that includes navigation information related to the field, such as information about how to access the identified screen in the software. The screen details field 530 also includes a description field 536 that provides a description of the screens captured in the screen evaluation chart 525.

The base-language screenshot field 540 includes a base-language screenshot 542 of a screen in the base-language software. The base-language screenshot includes one or more displayed screen elements (e.g., displayed writing, text, or other translatable information) in the base language such as the text of screen element 544 that reads “Save As,” which is in the English language. The localized-software screenshot field 550 includes a localized-software screenshot 552 of a screen in the localized software that is in a second language that is a different language than the base language of the base-language software. The localized-software screenshot includes one or more displayed screen elements (e.g., displayed writing, text, or other readable information) in the second language such as the text of screen element 554 which is in the French language.

In the example of FIG. 5A, the screen captured in the localized-software screenshot 552 is a corresponding screen (e.g., the same screen, substantially same screen, similar screen, translated screen, or the screen identified as the same or substantially same screen with a screen identifier) that corresponds with the screen captured in the base-language screenshot that is in the base-language software. The localized-software screenshot 552 shows a translated version of the screen in the base-language screenshot 542. In the localized-software screenshot 552, the readable screen elements are French language translations of the corresponding English language screen elements in the base-language screen shot. In the example, screen element 544 in the base-language screenshot corresponds to the screen element 554 in the localized-software screenshot, and the screen element 554 is a French translation.

In some implementations of screen maps, the translated screen maps can include errors in translation and/or the screen captured can be different than the screen shown in the base-language screenshot. For example, when a software is internationalized or localized to conform to cultural, political, linguistic, and/or technical constraints of a location where the software is to be released, the localized-software user interface and its screens and translated screen elements can differ slightly or greatly from the base-language software based on the constraints. In some implementations translation errors can include misspellings, typographic errors, mistranslations, and/or less accurate and/or appropriate translations. The verification field 560 can be used for capturing information about the validity of the translations of the screen elements in the localized-software screenshot from the corresponding screen elements in the base-language screenshot.

In the example, the verification field 560 includes information that one or more of the translated screen elements of the localized-software screenshot are validated and/or verified as proper translations at 562. In other implementations, where translated screen elements are not proper translations, a verification field can include information that one or more of the translated screen elements in the localized-software screenshot are not validated and/or not verified as proper translations.

FIG. 5B illustrates a portion of an exemplary implementation of a screen map. In FIG. 5B the screen map includes a table of contents 570 listing one or more sections of the screen map and a page number where the sections begin. In the example, the table of contents 570 includes a list of numbered sections including a purpose section and a screens section. Also the screen map of FIG. 5B includes a revision history 580 that includes one or more fields for a version number, a date, an author, and a description. Additionally, the screen map of FIG. 5B includes a definitions field 590 that includes one or more fields for terms included in the screen map and one or more corresponding fields for the definitions of the terms. The definitions field can aid a translator in the translation of a particular term.

The template shown in the screen map illustrated in FIGS. 5A and 5B can be used to create a screen map. In other implementations of a screen map, more or less information (e.g., more or less fields) are included in the screen map than shown in the screen map of FIGS. 5A-B. Additionally, in other implementations of a screen map, the information of the screen map is organized differently than illustrated in the screen map of FIGS. 5A-B. For example, the order and/or organization of the information is different than shown in the screen map illustrated in FIGS. 5A-B.

### Exemplary Implementation of a Stakeholder Matrix

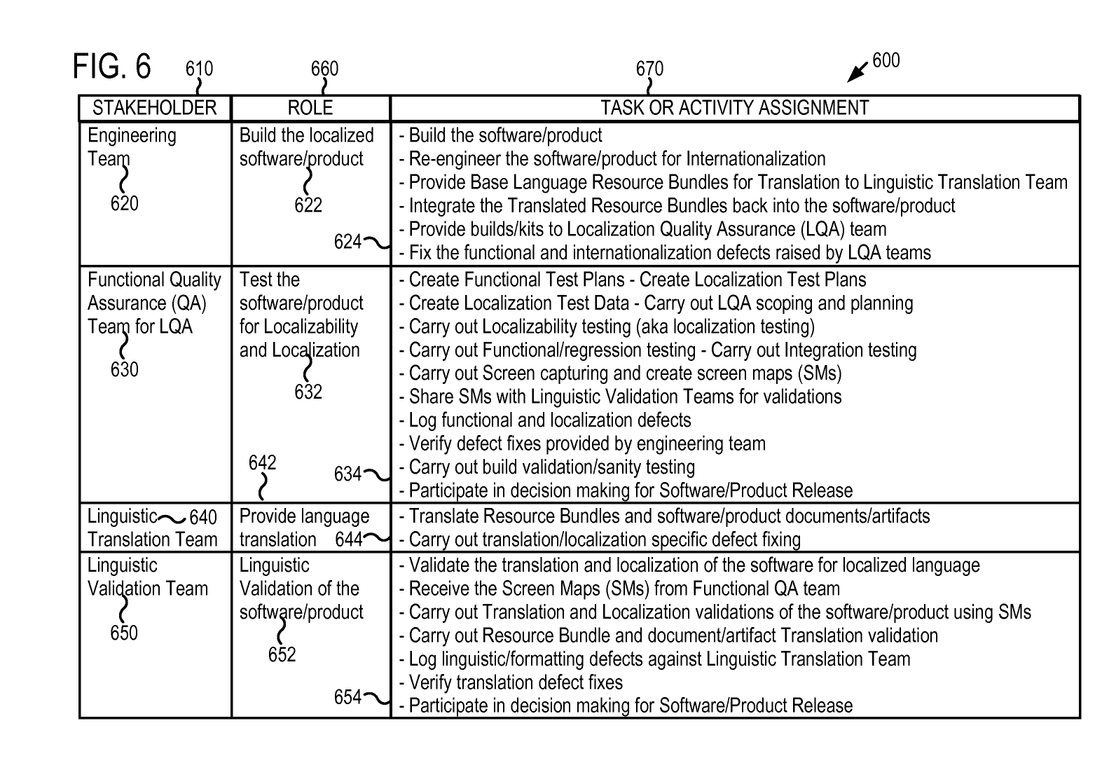

FIG. 6 illustrates an exemplary implementation of a stakeholder matrix 600. In FIG. 6, stakeholder matrix 600 includes a stakeholder field 610, a role field 660, and a localization quality assurance task or activity assignment field 670. The rows of the stakeholder matrix 600 associate a stakeholder with role information for the stakeholder and localization activity/task assignments for the stakeholder. In FIG. 6, at 620 an engineering team is listed as a stakeholder with the role of building the localized software product as shown at 622, and that is assigned localization quality assurance activities or tasks as shown at 624.

At 630 a functional QA team is listed as a stakeholder with the role of testing the localized software product for localizability and localization as shown at 632, and that is assigned localization quality assurance testing activities or tasks as shown at 634. The localization quality assurance testing activities or tasks assigned to the functional QA team such as those shown at 634 can be functional QA tasks. At 640, a linguistic translation team is listed as a stakeholder with the role of providing language translation as shown at 642, and that is assigned localization quality assurance activities or tasks as shown at 644. At 650, a linguistic validation team is listed as a stakeholder with the role of providing linguistic validation of the localized software product as shown at 652, and that is assigned localization quality assurance testing activities or tasks as shown at 654.

### Exemplary Implementation of a Feature Test Release Plan

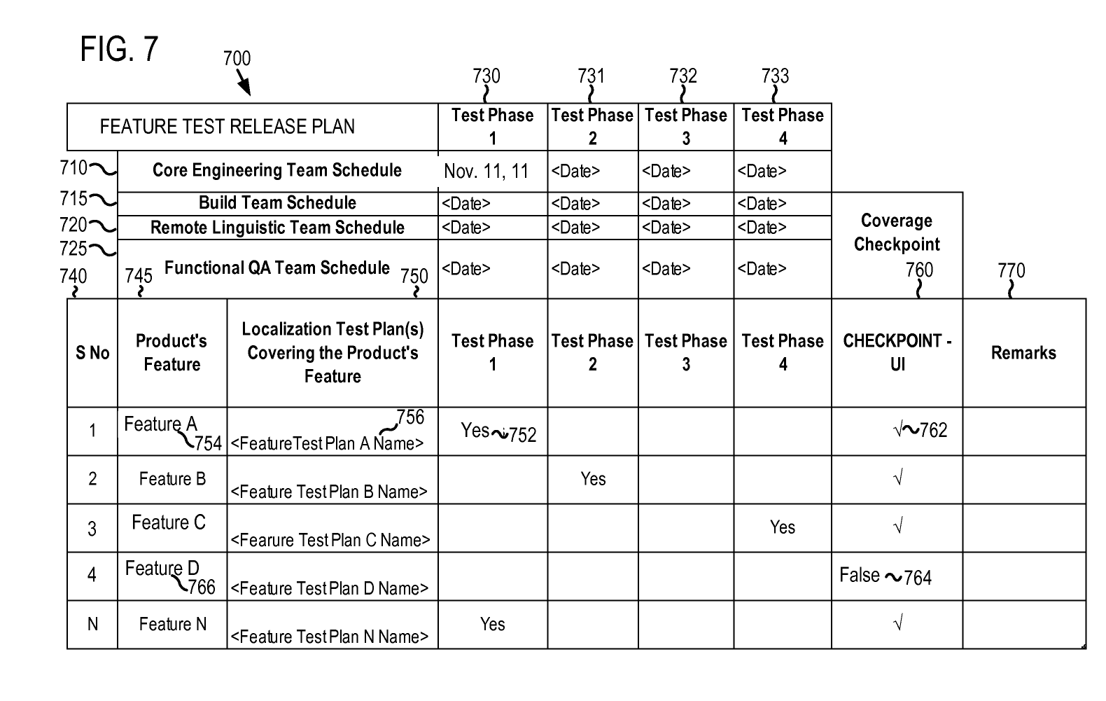

FIG. 7 illustrates an exemplary implementation of a feature test release plan 700. In FIG. 7, the feature test release plan 700 includes one or more fields indicating a schedule for an engineering team as show at 710. Also at 715, the feature test release plan 700 includes one or more fields indicating a schedule for a build team. At 720, the feature test release plan 700 includes one or more fields indicating a schedule for a linguistic team. At 725, the feature test release plan 700 includes one or more fields indicating a schedule for a functional QA team. In the example, the schedules for the teams include one or more dates for the respective teams to conduct work during one or more test phases as indicated by the dates in the test phase fields 730-733. Additionally, the feature test release plan includes one or more fields associating one or more test features with one or more feature test plans.

At 740, a number field is shown that lists a column of numbers identifying rows of information that associate a localized software feature to be tested with a feature test plan and other information. At 745, a field listing features of a localized software is shown. At 750 a field listing feature test plans or identifiers of feature test plans that are planned to be used to test an associated localized-software feature is shown. Additionally in the rows of information associated with localized-software features is information regarding which test phase one or more of the localized-software features are planned to be tested in.

Additionally, in some implementations, the feature test release plan can be updated to track which features have been tested during the performance of LQA of the localized software. In the example of FIG. 7, an indicator shown at 752 indicates that the localized-software feature 754 is to be tested or has been tested by the feature test plan 756 in the test phase indicated by test phase field 730.

In some implementations of the performance of LQA of a localized software a feature test coverage check can be conducted where indicators can be entered into the feature test release plan to track if a feature listed in the feature test release plan was tested before the coverage check. In some implementations, a feature test coverage check can occur after the planned test phases are completed or at some other time during the process of LQA of the localized software. The indicator 762 in one of the coverage checkpoint fields 760 indicates that the localized-software feature 754 was tested before the time of the feature test coverage check. The indicator 764 in one of the coverage checkpoint fields 760 indicates that the localized-software feature 766 was not tested before the time of the feature test coverage check. At 770 the feature test release plan 700 includes fields 770 for remarks regarding the testing or testing coverage of the listed localized-software features included in the feature test release plan 700.

### Exemplary Implementation of a Testing-Activities Coverage Matrix

In the performance of LQA of a localized software, various localization quality assurance testing activities or tasks can be performed. In some implementations of a localized-software LQA project, one or more localization quality assurance testing activities (LQA testing activities) of the project are performed according to or determined by one or more testing-activities coverage matrices and/or one or more feature test release plans included in the LQA plan for the localized-software LQA project. That is to say the one or more testing-activities coverage matrices or one or more feature test release plans can provide a guideline for the execution of LQA testing activities. A testing-activities coverage matrix can be used to avoid redundant performance of a particular LQA test activity over one or more test phases. For example, as one or more localized-software builds are generated over the LQA project duration, when one of the localized-software builds is determined to be relatively stable, sanity testing can be performed instead of regression testing (e.g., complete regression testing).

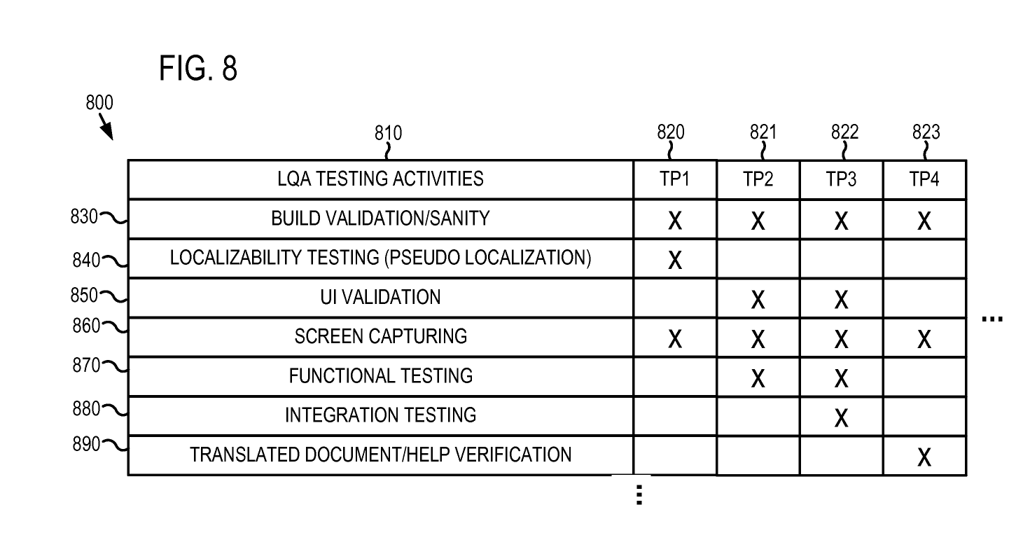

FIG. 8 illustrates an exemplary implementation of a testing-activities coverage matrix 800. The testing-activities coverage matrix 800 can be used to indicate which LQA testing activities are to be performed during respective test iterations or phases planned for the localized-software LQA project. Also, the testing-activities coverage matrix can be updated during the process of LQA of the localized software to indicate which LQA testing activities have been conducted during the test phases of the LQA process.

In FIG. 8, the testing-activities coverage matrix includes a localization quality assurance testing activities field 810 for listing LQA testing activities, and test phase fields 820-823 for listing which LQA testing activities are to be performed during the respective test phases of the localized-software LQA project. At 830 build validation and sanity testing is listed as an LQA testing activity in the testing-activities coverage matrix. For example, sanity testing can include testing that a localized-software build, when executed, functions as expected. In one exemplary implementation, when the performance of LQA of a localized software uses four test phases, sanity testing can be conducted in the third test phase and one or more subsequent test phases, and/or when localized-software builds are relatively stable. In some implementations, sanity testing can be done during a third test phase and/or one or more other test phases other than a third test phase. In some implementations, sanity testing is performed at other times during the LQA of a localized software such as during one or more test phases, or during the releasing of a localized software. In some implementations of build validation testing, build validation testing can include testing that detects build defects or issues that can be corrected so that the build is stable. In one implementation, build validation can be the first testing done on a localized-software build. Also, build validation testing can be done before or after other testing activities.

At 840, localizability testing is listed as an LQA testing activity in the testing-activities coverage matrix. Localizability testing can also be termed internationalization testing or pseudo-localization testing. Internationalization testing can detect one or more externalization and/or Unicode support defects (e.g., issues, bugs, errors, incompatibilities) in the localized software undergoing LQA. In some implementations, internationalization testing is performed by localization quality assurance teams while initial resource bundles are being translated by a localization translation team before a first localized-software build is created for testing in a test phase. This can allow early engagement of the localization quality assurance teams early in the LQA process of the localized software. Internationalization testing can also be performed at other times during the LQA process of the localized software such as during one or more test phases, or during the releasing of the localized software.

At 850, user interface validation is listed as an LQA testing activity in the testing-activities coverage matrix. For example, user interface validation can include linguistic validation testing. In one implementation of linguistic validation testing, localized-software screenshots of the user interface of the localized software are captured in screen maps. The screen maps are sent to a linguistic team for evaluation and/or validation. The linguistic team can evaluate and/or validate the screen maps and can update the screen maps with remarks of validation or indicating defects. The screen maps including the remarks can be sent to a linguistic translation team or an engineering team for correction or fixing of the defects or errors indicated in the screen map documents. The corrections or fixes can be incorporated into a subsequent localized-software build which has source code altered to include the correction or fixes. Also, the fixes reflected in the updated localized-software build can again be validated in another iteration of linguistic validation testing during another phase of testing. For example, when the performance of LQA of a localized software uses four test phases, linguistic validation testing can be conducted in the second and third test phases. The third test phase can test a localized-software build that includes the fixes of a previous localized-software build that was tested during the second test phase. In some implementations, linguistic validation can be conducted in the second, third, and/or one or more other test phases.

At 860, screen capturing is listed as an LQA testing activity in the testing-activities coverage matrix. For example, screens from a localized-software build and/or a base-language software can be captured as screenshots. The screen captures can be associated with identifiers, and/or other screen shots. For example, a screen in the base-language screen can be identified as associated with a screen from the localized-software build.

At 870, functional testing is listed as an LQA testing activity in the testing-activities coverage matrix. For example, functional testing can include testing that one or more localized-software builds support Unicode and testing for defects in functionality that are caused in the localized software because of its support for Unicode. In some implementations, existing functional test plans are executed. In one example, when the performance of LQA of a localized software uses four test phases, functional testing can be conducted in the second and third test phases. In some implementations, functional testing can be done in one or more test phases for LQA of a localized software.

At 880, integration testing is listed as an LQA testing activity in the testing-activities coverage matrix. For example, integration testing can include performing tests to check functionality of one or more modules that have been integrated into a build of the localized software. For example, integration testing can detect bugs or errors in the localized software that occur between or because of integrated modules.

At 890, document testing is listed as an LQA testing activity in the testing-activities coverage matrix. For example, document (doc) testing can include evaluating and/or validating the translations of documents that are associated with the localized software product such as help documents, manuals, and the like. In some implementations of document testing, testing of links in the documents is performed, or searching of localized text is performed.

Another testing activity that can be performed during LQA of a localized software is beta testing. Additionally, other testing activities that can be used to test a localized software can be done during the performance of LQA of the localized software.

In some implementations of performing LQA testing activities, LQA testing activities can be performed using automated scripts. To perform testing using the automated scripts, the automated scripts are executed by one or more computers. Automated scripts can be updated based on previous results from testing using the automated scripts. The testing and updating of automated scripts can be performed in one or more test phases of the LQA process of a localized software.

### Exemplary Implementation of a Communication Plan

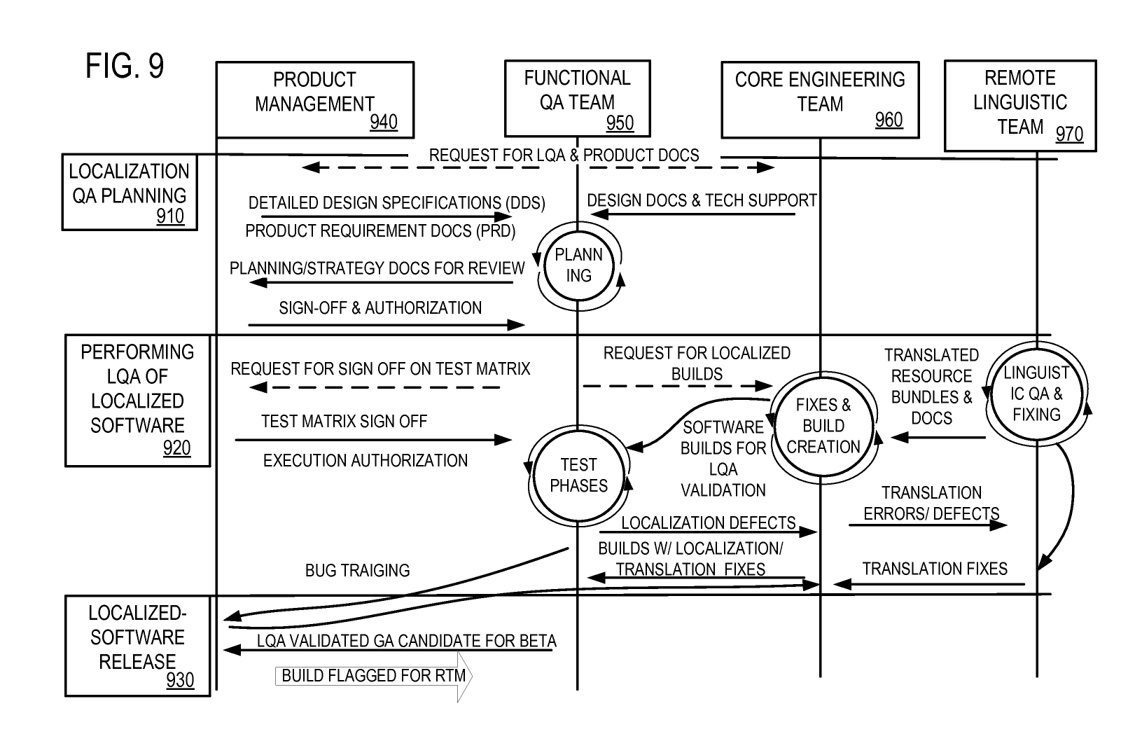

FIG. 9 is a schematic diagram illustrating an exemplary communication plan. In the figure, communications to and from a product management team 940, a functional QA team 950, an engineering team 960, and a linguistic team 970 are shown. The communications are arranged such that the communications are designated to be conducted during a phase of developing an LQA plan as shown at 910, during a phase of performing LQA of a localized software as shown at 920, or during a phase of releasing the localized software as shown at 930. In some implementations of a communication plan, the planned communications included in the communications plan can be based on the circumstances of a localized-software LQA project. For example, the planning of communications can be based on the location of one or more stakeholders, the number of stakeholders, the skillsets or domains of one or more stakeholders, the localization activities assigned to one or more stakeholders, one or more localized software LQA phases or test phases, and/or other circumstances.

### Exemplary Implementation of a Localization Quality Assurance Roadmap

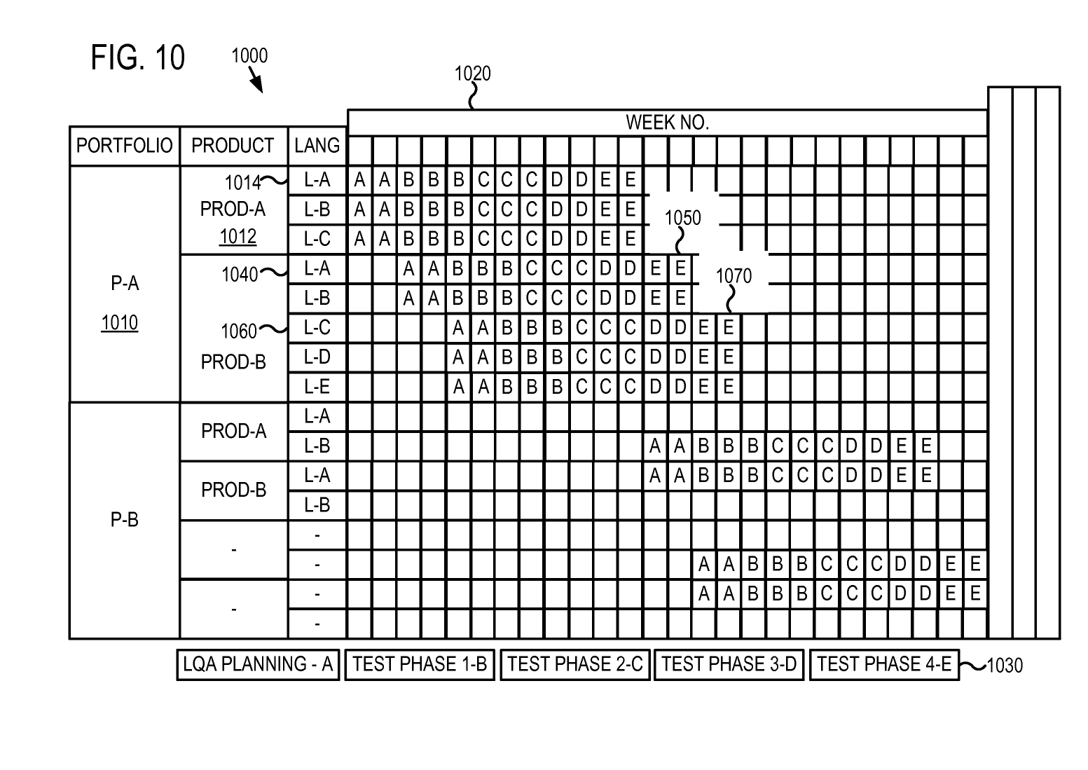

FIG. 10 illustrates an exemplary implementation of a localization quality assurance roadmap 1000. The localization quality assurance roadmap (LQA roadmap) 1000 includes a list of software product portfolios such as listed software product portfolio 1010. The LQA roadmap 1000 includes lists of base-language software products associated with respective software product portfolios such as base-language software product 1012 that is associated with product portfolio 1010. The LQA roadmap 1000 includes lists of localized softwares in various languages that are developed, or to be developed based on base-language softwares such as listed localized software 1014 that is to be developed based on base-language software 1012. Also, the LQA roadmap 1000 includes a schedule of when shared resources are to be shared during the LQA process of various localized software. In some implementations of resource sharing, resources can be shared between the LQA projects of various localized software that are based on a same or different base-language software. For example, the localized softwares undergoing LQA can be from the same or different software product portfolios.

The LQA roadmap 1000 includes times 1020 when resources are planned to be used for or are planned to be on-board a localized-software LQA project. The LQA roadmap 1000 indicates what resources are to be shared across various listed localized-software LQA projects. Shared resources can include shared teams, stakeholders, human resources, computing resources, tools, accelerators, infrastructure resources, and/or other resources. In one example of planned shared resources indicated by the LQA roadmap 1000, the resources used to perform a test phase 1030 are planned to conduct the test phase 1030 for localized software 1040 at the time shown at 1050. Then the resources used to perform a test phase 1030 are planned to conduct the test phase 1030 later for localized software 1060 at the time shown at 1070.

### Exemplary Computing System for Developing a Localized Software

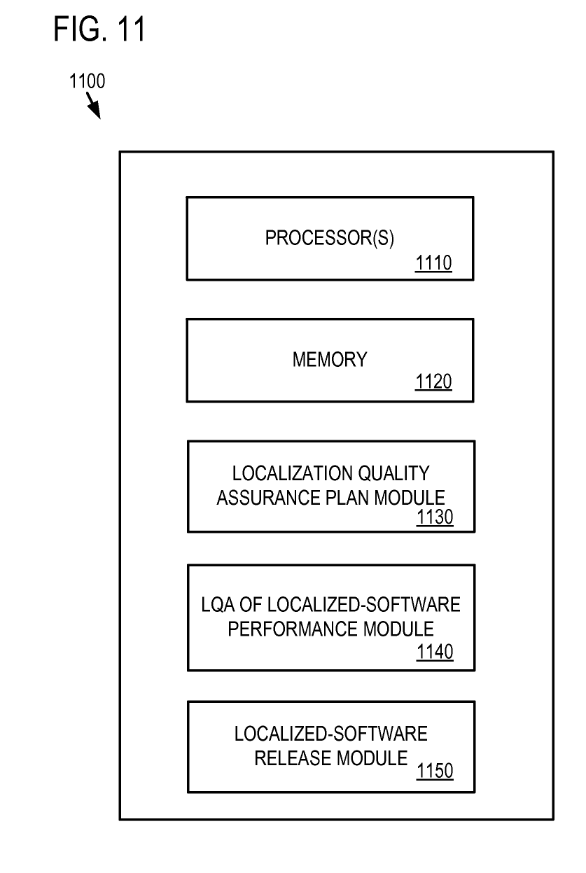

FIG. 11 is a schematic diagram illustrating an exemplary computing system 1100 for performing LQA of a localized software. In FIG. 11, the system 1100 includes one or more processors 1110, memory 1120, a localization quality assurance plan module 1130, a localization quality assurance of a localized-software performance module 1140, and a localized-software release module 1150. In some implementations of a computing system for developing a localized software, the computing system can include more or fewer modules and/or different modules. In one implementation, the memory 1120 stores computer-executable instructions that when executed by the computing system, cause the computing system to perform the functionality of the localization quality assurance plan module 1130, the localization quality assurance of a localized-software performance module 1140, and/or the localized-software release module 1150. The localization quality assurance plan module 1130 is configured to and can be used to implement one or more implementations for developing an LQA plan as described herein and/or updating the LQA plan during a localized-software LQA project as described herein. The localization quality assurance of a localized-software performance module 1140 is configured to and can be used to implement one or more implementations for performing LQA of a localized software as described herein. The localized-software release module 1150 is configured to and can be used to implement one or more implementations of releasing a localized software as described herein.

### Exemplary Computing Environment

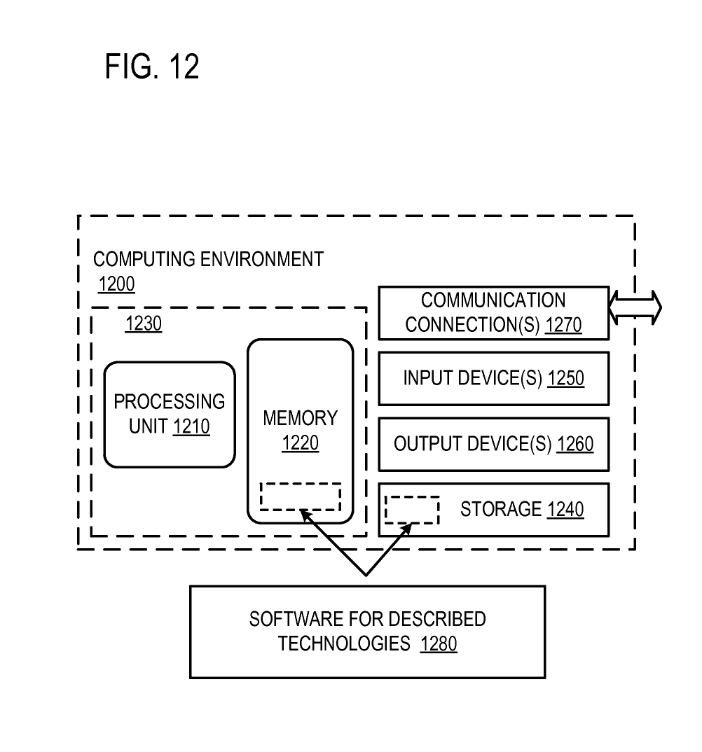

FIG. 12 illustrates a generalized example of a suitable computing environment 1200 in which herein described embodiments, techniques, solutions, and technologies may be implemented. The computing environment 1200 is not intended to suggest any limitation as to scope of use or functionality of the technology, as the technology may be implemented in diverse general-purpose or special-purpose computing environments. For example, the disclosed technology may be implemented using one or more computing devices comprising a processing unit, memory, and storage storing computer-executable instructions implementing the technologies described herein. For example, computing devices include server computers, desktop computers, laptop computers, notebook computers, netbooks, tablet computers, mobile devices, PDA devices and other types of computing devices (e.g., devices such as televisions, media players, or other types of entertainment devices that comprise computing capabilities such as audio/video streaming capabilities and/or network access capabilities). The disclosed technology may also be implemented with other computer system configurations, including hand held devices, multiprocessor systems, microprocessor-based or programmable consumer electronics, network PCs, minicomputers, mainframe computers, a collection of client/server systems, or the like. The disclosed technology may also be practiced in distributed computing environments where tasks are performed by remote processing devices that are linked through a communications network (e.g., a local network, non-local network, and/or the Internet). In a distributed computing environment, program modules may be located in both local and remote memory storage devices. Additionally, the techniques, technologies, and solutions described herein can be performed in a cloud computing environment (e.g., comprising virtual machines and underlying infrastructure resources).

With reference to FIG. 12, the computing environment 1200 includes at least one central processing unit 1210 and memory 1220. In FIG. 12, this basic configuration 1230 is included within a dashed line. The central processing unit 1210 executes computer-executable instructions. In a multi-processing system, multiple processing units execute computer-executable instructions to increase processing power and as such, multiple processors can be running simultaneously. The memory 1220 may be volatile memory (e.g., registers, cache, RAM), non-volatile memory (e.g., ROM, EEPROM, flash memory, etc.), or some combination of the two. The memory 1220 stores software 1280 that can, for example, implement one or more of the technologies described herein. A computing environment may have additional features. For example, the computing environment 1200 includes storage 1240, one or more input devices 1250, one or more output devices 1260, and one or more communication connections 1270. An interconnection mechanism (not shown) such as a bus, a controller, or a network, interconnects the components of the computing environment 1200. Typically, operating system software (not shown) provides an operating environment for other software executing in the computing environment 1200, and coordinates activities of the components of the computing environment 1200.

The storage 1240 may be removable or non-removable, and includes magnetic disks, magnetic tapes or cassettes, CD-ROMs, CD-RWs, DVDs, or any other tangible storage medium which can be used to store information and which can be accessed within the computing environment 1200. The storage 1240 stores computer-executable instructions for the software 1280, which can implement technologies described herein.

The input device(s) 1250 may be a touch input device, such as a keyboard, keypad, mouse, touch screen, controller, pen, or trackball, a voice input device, a scanning device, or another device, that provides input to the computing environment 1200. For audio, the input device(s) 1250 may be a sound card or similar device that accepts audio input in analog or digital form, or a CD-ROM reader that provides audio samples to the computing environment 1200. The output device(s) 1260 may be a display, printer, speaker, CD-writer, DVD-writer, or another device that provides output from the computing environment 1200.

The communication connection(s) 1270 enable communication over a communication medium (e.g., a connecting network) to another computing entity. The communication medium conveys information such as computer-executable instructions, compressed graphics information, compressed or uncompressed video information, or other data in a modulated data signal.

### FURTHER CONSIDERATIONS

Any of the disclosed methods can be implemented using computer-executable instructions stored on one or more computer-readable media (tangible computer-readable storage media, such as one or more optical media discs, volatile memory components (such as DRAM or SRAM), or nonvolatile memory components (such as hard drives)) and executed on a computing device (e.g., any commercially available computer, including smart phones or other mobile devices that include computing hardware). By way of example, computer-readable media include memory 1220 and/or storage 1240. As should be readily understood, the term computer-readable media does not include communication connections (e.g., 1270) such as modulated data signals.

Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to a particular type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. We therefore claim as our invention all that comes within the scope of these claims and their equivalents.

We claim:

1. A method implemented at least in part by a computer, the method comprising:
developing a localization quality assurance plan for performing localization quality assurance of at least a localized software based at least in part on a base language software, the base language software comprising a first user interface in a first language, and the localized software comprising a second user interface in a second language;
using the localization quality assurance plan, performing the localization quality assurance of the localized software at least by performing a first test phase of one or more test phases, the first test phase comprising:
using first location resources at a first location, creating one or more screen maps for a first localized-software build;
using second location resources at a second location, evaluating the one or more screen maps;
based at least in part on the evaluating, generating one or more resource bundles for the first localized-software build; and
based at least in part on the one or more resource bundles, generating a second localized-software build using the first location resources.

2. The method of claim 1 further comprising evaluating a localization quality assurance report; and
based at least in part on the evaluation of the localization quality assurance report, releasing the localized software.

3. The method of claim 1, wherein the second user interface comprises an internationalized version of the first user interface translated into the second language.

4. The method of claim 1, wherein the localization quality assurance plan comprises a stakeholder matrix, a feature test release plan, a testing-activities coverage matrix, a schedule metric, a quality metric, a communication plan, or a localization quality assurance roadmap.

5. The method of claim 1, further comprising sending the one or more screen maps from the first location to the second location; and
sending the one or more resource bundles from the second location to the first location.

6. The method of claim 4, wherein the sending the one or more screen maps from the first location to the second location is based on a communication plan, wherein the localization quality assurance plan comprises the communication plan.

7. The method of claim 1, wherein the first location resources comprise a functional quality assurance team and the second location resources comprise a linguistic team.

8. The method of claim 1, wherein the first localized-software build comprises an internationalized software build comprising at least a portion of the second user interface in the second language.

9. The method of claim 1, wherein evaluating the one or more screen maps comprises evaluating a translation of a screen element, wherein the evaluating comprises validating that the translation is validated or indicating that the translation is not validated.

10. The method of claim 1, wherein the performing the localization quality assurance of the localized software further comprises functional testing, build validation testing, automation testing, integration testing, document testing, defect logging, or defect verification.

11. The method of claim 1, wherein a screen map of the one or more screen maps comprises at least one screen capture of the base-language software and at least one screen capture of the first localized-software build.

12. The method of claim 1, wherein the one or more test phases are iterative; and
wherein respective test phases of the one or more test phases test different localized-software builds.

13. The method of claim 12, wherein the one or more test phases comprise a second iterative test phase, the second iterative test phase comprising:
creating one or more screen maps for the second localized-software build;
evaluating the one or more screen maps for the second localized-software build;
generating one or more resource bundles for the second localized-software build; and
based at least in part on the one or more resource bundles for the second localized-software build, generating a third localized-software build using the first location resources.

14. The method of claim 1, wherein the performing the localization quality assurance of the localized software further comprises translating initial resource bundles.

15. A method comprising:
developing a localization quality assurance plan for performing the localization quality assurance of at least a localized software based at least in part on a base language software, the developing comprising assigning a first set of one or more localization quality assurance tasks to a first team and assigning a second set of one or more localization quality assurance tasks to a second team; and
using the localization quality assurance plan, performing the localization quality assurance of at least the localized software comprising a user interface in a second language that is different than the base language, the performing the localization quality assurance comprising:
using at least the first team and a set of one or more computers at a first location, creating one or more screen maps for a first localized-software build;
using at least the second team and a second set of one or more computers at a second location, evaluating the one or more screen maps; and
based at least in part on the evaluating, generating one or more resource bundles; and
based at least in part on the one or more resource bundles, generating a second localized-software build using at least the first team at the first location.

16. The method of claim 15, wherein developing the localization quality assurance plan further comprises:
enumerating one or more features of the localized software; and
enumerating one or more feature test plans; and
wherein performing localization quality assurance of the localized software further comprises:
testing one or more of the enumerated one or more features of the localized software; and
tracking the testing of the one or more of the enumerated one or more features of the localized software.

17. The method of claim 15, wherein the first set of the one or more localization quality assurance tasks are functional quality assurance tasks, and the second set of the one or more localization quality assurance tasks are linguistic tasks.

18. The method of claim 15, wherein the localization quality assurance plan comprises a communication plan describing communications between at least the first and second teams;
wherein the first set of one or more screen maps is sent from the first location to the second location consistent with the communication plan; and
wherein the one or more resource bundles are sent from the second location to the first location consistent with the communication plan.

19. The method of claim 15, wherein the localized software is a first localized software;
wherein the localization quality assurance plan further comprises a localization quality assurance roadmap comprising a schedule for sharing one or more resources between the performing the localization quality assurance of the first localized software and a performing of localization quality assurance of at least a second localized software; and
performing the localization quality assurance of at least the second localized software using at least one of the one or more resources as scheduled by the localization quality assurance roadmap.

20. A method implemented at least in part by a computer, the method comprising:
developing a localization quality assurance plan for performing localization quality assurance of at least a localized software based at least in part on a base language software, the localization quality assurance plan comprising a feature test release plan that at least enumerates one or more feature test plans;
performing localization quality assurance for at least the localized software comprising a user interface in a second language that is different than the base language, the performing the localization quality assurance comprising:
testing one or more features of a first localized-software build;
creating one or more screen maps for the first localized-software build;
using second location resources at a second location, evaluating the one or more screen maps;
based at least in part on the evaluating, generating one or more resource bundles for the first localized-software build; and
based at least in part on the one or more resource bundles, generating a second localized-software build using the first location resources; and
tracking the performing the localization quality assurance of the localized software at least by updating the localization quality assurance plan, the updating comprising:
at least based on the testing of the one or more features of the first localized-software build, updating the feature test release plan to indicate that at least one of the one or more features of the localized software has been tested in a test phase of one or more test phases.
